(19) United States
(12) Patent Application Publication
(10) Pub. No.: US 2026/0367557 A1
(43) Pub. Date: Nov. 19, 2026

(54) FIXING DEVICE, IMAGE FORMING APPARATUS, AND FIXING PARAMETER CHANGING METHOD

(71) Applicant: Konica Minolta, Inc., Tokyo (JP)

(72) Inventor: Kohei SUGAWARA, Toyokawa-shi (JP)

(21) Appl. No.: 19/676,044

(22) Filed: May 13, 2026

(30) Foreign Application Priority Data
May 14, 2025 (JP) 2025-081073

(51) Int. Cl. G03G 15/00; G03G 15/20

(52) U.S. Cl. CPC G03G 15/5004; G03G 15/205; G03G 15/2053; G03G 15/55; G03G 15/2064

(57) ABSTRACT

A fixing device provided in an image forming apparatus and including a fixing belt and a heater, the fixing device including: a reflector configured to reflect heat from the heater toward an inner surface of the fixing belt, a deterioration sensor configured to detect a deterioration state of the reflector, a hardware processor configured to change a fixing parameter based on the detected deterioration state; and a corrector configured to correct a variation in a power supply voltage supplied to the image forming apparatus.

### CROSS-REFERENCE TO RELATED APPLICATION

The entire disclosure of Japanese Patent Application No. 2025-081073, filed on May 14, 2025, including description, claims, drawings and abstract is incorporated herein by reference.

### BACKGROUND OF THE INVENTION

### Technical Field

The present disclosure relates to a fixing device, an image forming apparatus, and a fixing parameter changing method.

### Description of Related Art

In the related art, an image forming apparatus, such as an electrophotographic method printer, includes a fixing device that fixes a toner image to a sheet by heating and pressing the sheet onto which the toner image has been transferred. Further, for energy saving, a fixing device is known that includes a reflector plate configured to reflect heat from a (halogen) heater installed inside a fixing belt toward an inner surface of the fixing belt. However, in the fixing device including the reflector plate, reflectance may decrease due to deterioration of the reflector plate. When the reflectance decreases, a heat amount supplied to the toner decreases, which may lead to an image defect in which a fused image peels off.

For this reason, an image forming apparatus is known that detects a deterioration state of the reflector plate based on a temperature rise rate of the temperature of the reflector plate detected by a thermistor (see Japanese Unexamined Patent Application Publication No. 2012-13765).

However, since the temperature rise rate is affected by electric power supplied to the heater, detection accuracy of the deterioration state decreases due to variations in a power supply voltage in a region with poor power supply conditions. For this reason, the image forming apparatus of Japanese Unexamined Patent Application Publication No. 2012-13765 may be insufficient to determine the deterioration state.

### SUMMARY OF THE INVENTION

An object of the present disclosure is to accurately detect a deterioration state of a reflecting section (reflector plate), even in a region with poor power supply conditions, and to change a fixing parameter.

In order to solve the above-described problems, according to an aspect of the present disclosure, a fixing device reflecting one aspect of the present disclosure is the fixing device provided in an image forming apparatus and including a fixing belt and a heater, the fixing device including:
a reflector configured to reflect heat from the heater toward an inner surface of the fixing belt,
a deterioration sensor configured to detect a deterioration state of the reflector,
a hardware processor configured to change a fixing parameter based on the detected deterioration state; and
a corrector configured to correct a variation in a power supply voltage supplied to the image forming apparatus.

According to another aspect of the present disclosure, a fixing parameter changing method reflecting one aspect of the present disclosure is the fixing parameter changing method performed in a fixing device that is provided in an image forming apparatus and that includes a fixing belt and a heater, the method including:
detecting a deterioration state of a reflector configured to reflect heat from the heater toward an inner surface of the fixing belt;
changing a fixing parameter based on the detected deterioration state; and
correcting a variation in a power supply voltage supplied to the image forming apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a schematic diagram illustrating an overall configuration of an image forming apparatus according to a first embodiment of the present disclosure;

FIG. 2 is a block diagram illustrating a functional configuration of the image forming apparatus;

FIG. 3 is a side view of a fixing section;

FIG. 4 is a perspective view illustrating a heating section of the first embodiment;

FIG. 5 is a view illustrating a cross-section of a reflecting section and illustrating a contact;

FIG. 6 is a diagram illustrating AC power-supply power;

FIG. 7 is a circuit diagram of a measurement section;

FIG. 8 is a flowchart illustrating a first deterioration state measurement process;

FIG. 9 is a flowchart illustrating a first fixing parameter changing process;

FIG. 10 is a flowchart illustrating a second fixing parameter changing process;

FIG. 11 is a flowchart illustrating a third fixing parameter changing process;

FIG. 12 is a flowchart illustrating a fourth fixing parameter changing process;

FIG. 13 is a diagram illustrating a reflectance of the reflecting section with respect to a resistance value in a thickness direction of a reflecting layer;

FIG. 14 is a diagram illustrating the reflectance of the reflecting section with respect to the resistance value of a combined resistance in a longitudinal direction of a base layer and the reflecting layer;

FIG. 15 is a flowchart illustrating a second deterioration state measurement process;

FIG. 16 is a flowchart illustrating a first initial process;

FIG. 17 is a flowchart illustrating a first deterioration state conversion process;

FIG. 18 is a flowchart illustrating a third deterioration state measurement process;

FIG. 19 is a flowchart illustrating a fourth deterioration state measurement process;

FIG. 20 is a diagram illustrating a temperature rise rate of a fixing belt with respect to the reflectance of the reflecting section;

FIG. 21 is a flowchart illustrating a fifth deterioration state measurement process;

FIG. 22 is a flowchart illustrating a sixth deterioration state measurement process;

FIG. 23 is a perspective view of a heating section according to the fourth embodiment;

FIG. 24 is a flowchart illustrating a second initial process;

FIG. 25 is a flowchart illustrating a second deterioration state conversion process; and

FIG. 26 is a perspective view illustrating the heating section according to the fourth embodiment.

### DETAILED DESCRIPTION

Hereinafter, one or more embodiments of the present disclosure will be described with reference to the drawings. However, the scope of the invention is not limited to the disclosed embodiments.

The advantages and features provided by one or more embodiments of the present disclosure will be more fully understood from the following detailed description and the accompanying drawings. However, the drawings are for illustrative purposes only. Accordingly, this is not intended to define the limits of the present disclosure. Hereinafter, embodiments of the present disclosure will be described with reference to the drawings. However, the scope of the present disclosure is not limited to the disclosed embodiments.

### First Embodiment

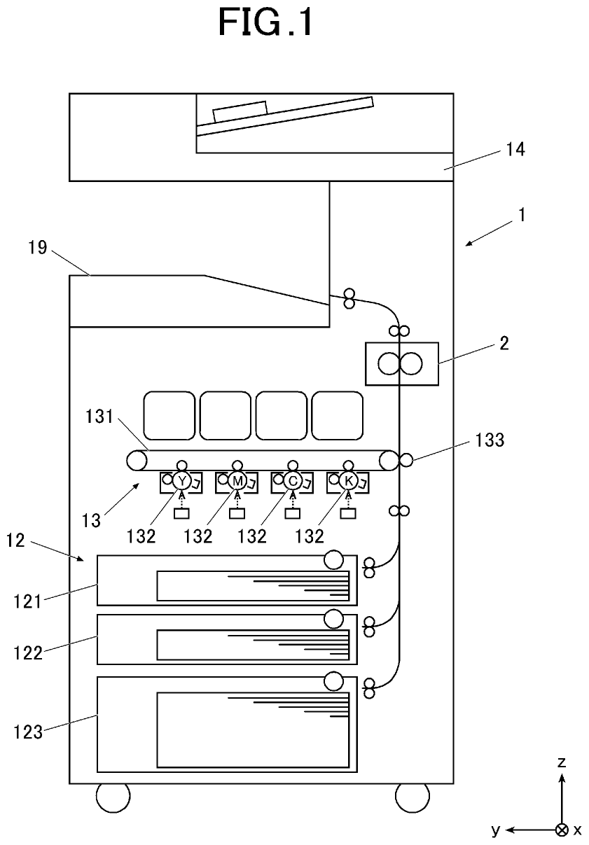

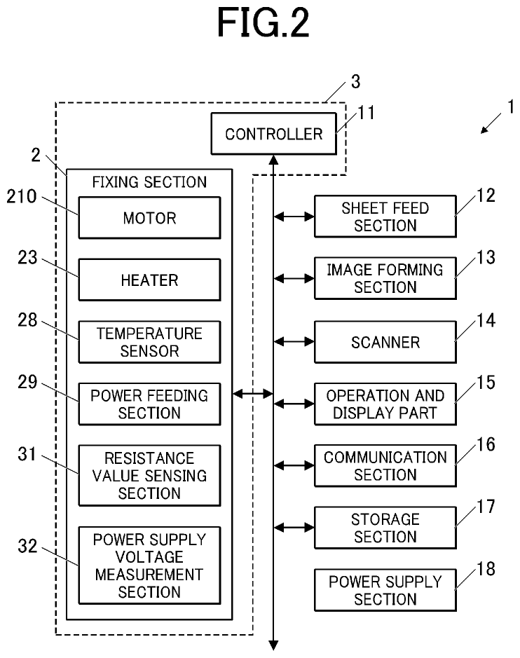

A first embodiment of the present disclosure will be described with reference to FIGS. 1 to 14. First, a configuration of an apparatus according to the present embodiment will be described with reference to FIGS. 1 to 7. FIG. 1 is a schematic diagram illustrating an overall configuration of an image forming apparatus 1 according to the present embodiment. FIG. 2 is a block diagram illustrating a functional configuration of the image forming apparatus 1.

As shown in FIG. 1, the image forming apparatus 1 is an MFP (Multi-Function Peripheral) and forms an image on paper (sheet) by an electrophotographic method based on print data. The image forming apparatus 1 includes a sheet feed section 12, an image forming section 13, a scanner 14, a fixing section 2, a sheet ejection tray 19, and the like. In FIG. 1, three-dimensional x-, y-, and z-axes are defined. The three axes are similarly defined in the other drawings of the fixing sections.

The sheet feed trays 121 to 123 store sheets according to sheet type, size, and the like. The image forming section 13 forms a toner image by transferring toner (colorant) onto the sheet supplied from the sheet feed section 12. The image forming section 13 includes an intermediate transfer belt 131, an image forming unit 132, and a transfer roller 133. The intermediate transfer belt 131 is an endless belt-shaped member stretched around a plurality of rollers and configured to circulate.

The image forming unit 132 includes image forming units for respective colors of Y (yellow), M (magenta), C (cyan), and K (black). The image forming units of each color includes a photosensitive drum, a charging section, an exposure section, a developing section, a cleaning section, and the like. In the image forming unit, the charging section charges a surface of the photosensitive drum, the exposure section exposes the charged surface to light based on image data of print data, and the developing section supplies the toner to an exposed surface to develop the toner image. Each of the image forming units of each color forms, by development, the toner image on the surface of the photosensitive drum, and removes excess toner by the cleaning section.

The image forming unit 132 is arranged along the intermediate transfer belt 131. The image forming unit 132 performs primary transfer of the toner images of respective YMCK colors onto the intermediate transfer belt 131 to form the color toner image, based on the image data included in the print data. The transfer roller 133 contacts the intermediate transfer belt 131 to form a nip. When a sheet passes through the nip, the transfer roller 133 performs secondary transfer of the toner image on the intermediate transfer belt 131 onto the sheet, thereby forming the image. In the present embodiment, the image forming section 13 capable of forming a color image is exemplified, however, the present disclosure is not limited thereto, and the image forming section 13 capable of forming a monochrome image may be used.

The fixing section 2 applies heat and pressure to the sheet to which the toner image has been transferred, thereby melting the toner image and fixing the toner image to the sheet. The fixing section 2 will be described in detail later.

The sheet ejection tray 19 supports the sheet on which the image has been formed and which has been discharged through a predetermined conveyance route. The scanner 14 includes a light source, an optical system including a reflecting mirror, and an imaging element. The scanner 14 reads, using an optical system and an imaging element, the image of the sheet conveyed along a predetermined conveyance route or a document placed on a platen glass, and generates the image data.

An internal functional configuration of the image forming apparatus 1 will be described with reference to FIG. 2. The image forming apparatus 1 includes a controller 11 (hardware processor), a fixing section 2, a sheet feed section 12, an image forming section 13, a scanner 14, an operation and display part 15, a communication section 16, a storage section 17, and a power supply section 18. Each unit of the image forming apparatus 1 is connected via a bus. According to the present embodiment, the controller 11, a later-described light amount measurement section 40, and light amount sensors 411 and 412 function as a deterioration sensing section (deterioration sensor).

The controller 11 includes a central processing unit (CPU), a random access memory (RAM), and the like, and controls the respective units of the image forming apparatus 1. The CPU reads a program stored in the storage section 17, stores the program in the RAM, and executes various processes in cooperation with the program stored in the RAM. The RAM provides a working memory space to the CPU and temporarily stores data. For example, in an image forming process, the controller 11 operates the respective units of the image forming apparatus 1 based on the image data stored in the storage section 17 to form the image on the sheet.

The sheet feed section 12, under control of the controller 11, picks up sheets from the sheet feed trays 121 to 123 and feeds the sheets to the image forming section 13. Under control of the controller 11, the image forming section 13 forms the toner image on the sheet supplied from the sheet feed section 12 based on the image data included in the print data. Under control of the controller 11, the fixing section 2 heats and presses the sheet on which the toner image has been formed, thereby fixing the image.

The operation and display part 15 includes, a display part (e.g., a liquid crystal display), and an operation part including a touch screen arranged to overlay a screen of the display part, and operation keys. Under the control of the controller 11, the display part displays various types of display information, such as an operation status and processing results, of the image forming apparatus 1. The operation part receives an operation input from a user and outputs operation information to the controller 11.

The communication section 16 includes a network card, for example. The communication section 16 is connected to a communication network (e.g., a local area network (LAN)) and transmits and receives information to and from an external device on the communication network. The controller 11 communicates, via the communication section 16, with an external device on a communication network.

The storage section 17 is a nonvolatile storage section, such as a hard disk drive (HDD) or a solid state drive (SSD). The storage section 17 stores various data, such as the image data input via the scanner 14 or the communication section 16, and various programs. In particular, the storage section 17 stores a first deterioration state measurement program and a first fixing parameter change program. The first deterioration state measurement program is a program for executing a first deterioration state measurement process described below. The first fixing parameter change program is a program for executing a first fixing parameter changing process described below.

The power supply section 18 appropriately converts power-supply power supplied from a commercial AC power source and supplies the converted power to each component of the image forming apparatus 1.

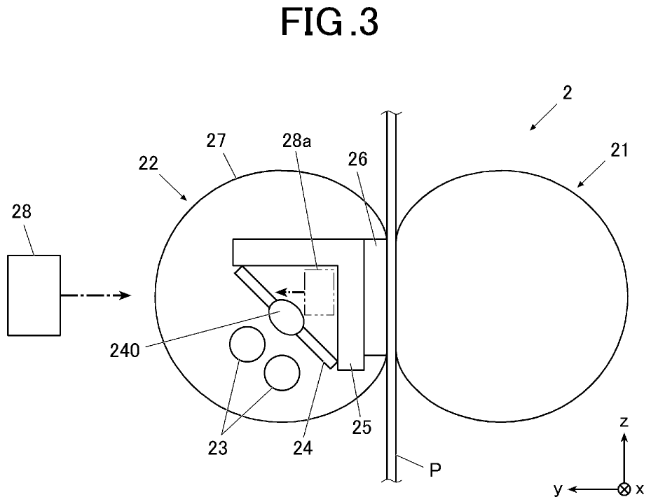

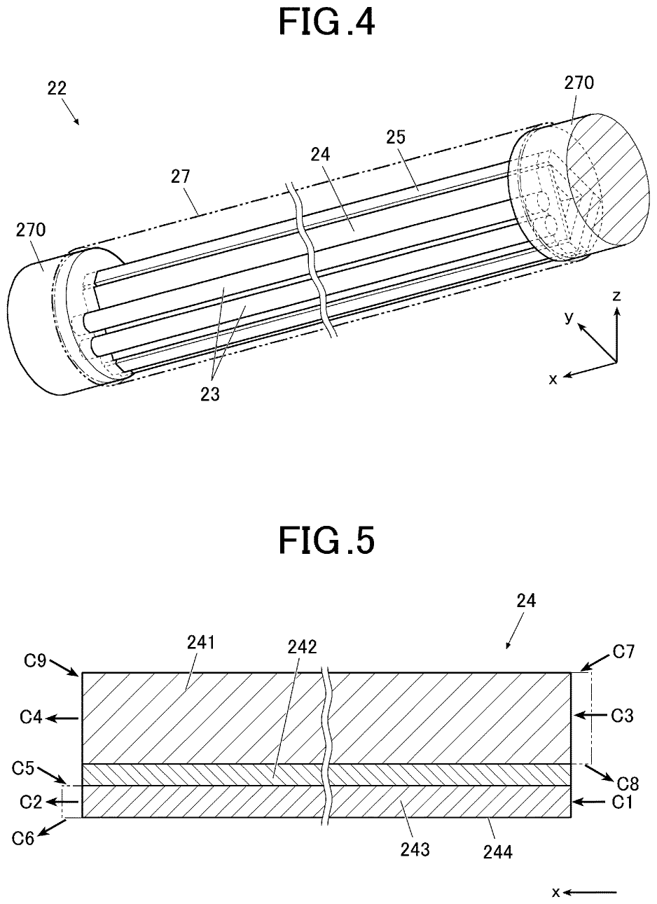

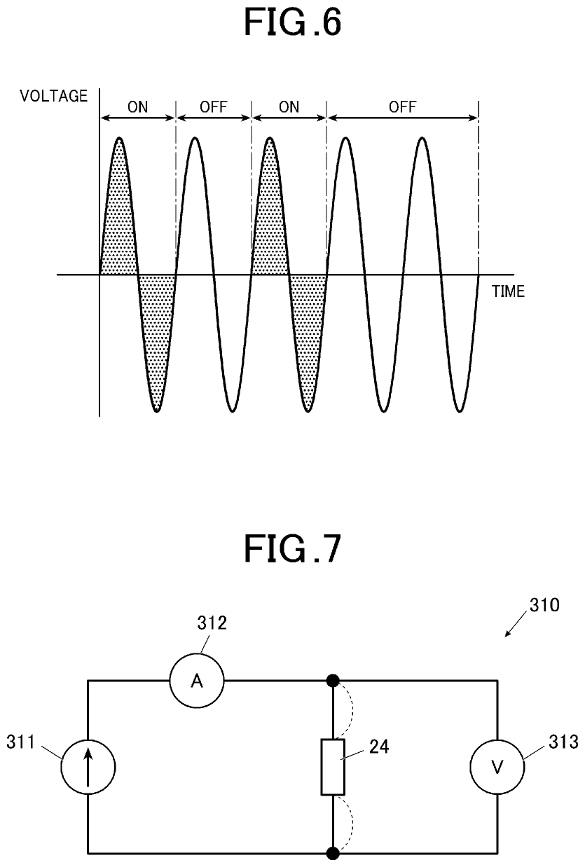

Next, with reference to FIGS. 2 to 7, a more detailed device configuration of the fixing section 2 will be described. FIG. 3 is a side view of the fixing section 2. FIG. 4 is a perspective view of a heating section 22. FIG. 5 is a diagram showing a cross-sectional view of the reflecting section 24 and contacts C1 to C9. FIG. 6 is a diagram illustrating AC power-supply power. FIG. 7 is a circuit diagram of a measurement section 310.

As shown in FIGS. 2 to 4, the fixing section 2 includes a pressure roller 21, a motor 210, the heating section 22, a temperature sensor 28, a power feeding section (power feeder) 29, a resistance value sensing section 31, and a power supply voltage measurement section 32. The heating section 22 includes a heater 23, a reflecting section (reflector) 24, a support portion 25, a fixing pad 26, a fixing belt 27, and a holding section 270.

The pressure roller 21 is a roller disposed in contact with the heating section 22. The pressure roller 21 applies the pressure to a sheet P on which the toner image is formed and which is conveyed. The motor 210 rotationally drives the pressure roller 21 under the control of the controller 11.

The heating section 22 is disposed in contact with the pressure roller 21 and is driven to rotate in accordance with rotation of the pressure roller 21. The heating section 22 heats the sheet P on which the toner image is formed and which is conveyed. The nip is formed in a contact portion between the pressure roller 21 and the heating section 22. The sheet P is conveyed from the-z direction to the +z direction through the nip by rotation of the pressure roller 21.

The heater 23 is, for example, a halogen heater, and generates heat (and radiates light). The reflecting section 24 is a reflector plate disposed to face the heater 23. The reflecting section 24 reflects, toward the fixing belt 27, the light emitted from the heater 23 in a direction opposite to the fixing belt 27, thereby supplying the heat to the fixing belt 27. As shown in FIG. 5, the reflecting section 24 has, for example, a four-layer structure. The reflecting section 24 includes, in order from the support portion 25 side toward the heater 23 side, a base layer 241, an adhesive layer 242, a reflecting layer 243, and a reflection-enhancing layer 244.

The base layer 241 is a base material of the reflecting section 24 and is made of, for example, aluminum. The adhesive layer 242 is an adhesive layer between the base layer 241 and the reflecting layer 243, and is formed of, for example, an anodized aluminum layer. The adhesive layer 242 may be omitted. The reflecting layer 243 is a layer that reflects heat (light) generated by the heater 23, and is made of, for example, silver. The reflection-enhancing layer 244 is a surface layer of the reflecting layer 243, is a layer that increases reflection of the heat (light) generated by the heater 23, and is, for example, a dielectric multilayer film.

Referring back to FIGS. 2 to 4, the support portion 25 is a support portion that supports the reflecting section 24. The support portion 25 is made of sheet metal of an iron-based material, such as stainless steel or an electrogalvanized steel sheet. The fixing pad 26 is disposed on the pressure roller 21 side and between the support portion 25 and the fixing belt 27. The fixing pad 26 does not rotate with the pressure roller 21. Accordingly, the fixing pad 26 includes a configuration in which a material having good slidability (e.g., metal) is wrapped around a pad made of a liquid crystal polymer (LCP)-based resin.

The fixing belt 27 is a cylindrical endless belt and covers components from the heater 23 to the fixing pad 26. The fixing belt 27 has, for example, a four-layer structure. The four layers of the fixing belt 27 include, in order from an inner side to an outer side, an inner surface layer, a base layer, an elastic layer, and a surface layer. The inner surface layer is made of, for example, polyimide (PI) or thermoplastic elastomer. The base layer is made of, for example, Ni or stainless steel. The elastic layer is made of, for example, silicone rubber. The surface layer is made of, for example, perfluoroalkoxy alkane (PFA) or polyimide (PI). The fixing belt 27 may have a three-layer structure including, in order from an inner side toward an outer side, a base layer, an elastic layer, and a surface layer. According to this configuration, the base layer is made of, for example, polyimide (PI) or thermoplastic elastomer. The heating section 22 supplies the heat from the heater 23 directly to the fixing belt 27.

The holding section 270 is a cylindrical member that holds (i.e., regulates and supports), from inside, both axial direction end portions of the fixing belt 27 so as to be rotatable about an axial center. The holding section 270 is made of, for example, a resin such as liquid crystal polymer (LCP) or polyimide (PI).

The temperature sensor 28 is disposed outside the heating section 22 (fixing belt 27), so as to face the fixing belt 27. The temperature sensor 28 detects the temperature of the fixing belt 27 and outputs measured temperature information to the controller 11. The temperature sensor 28 is also shared with a temperature sensor for adjusting a temperature of the fixing belt 27 during warm-up or the like. The temperature sensor 28 may be replaced with a temperature sensor 28a, for example, as indicated by the dotted line in FIG. 3. The temperature sensor 28a is disposed inside the heating section 22 (fixing belt 27), and measures the temperature of the reflecting section 24. Further, the temperature sensor 28 may be disposed on an upper side (+z-direction side) of the support portion 25 on the inner side of the heating section 22 (fixing belt 27) to measure the temperature of the fixing belt 27.

The power feeding section 29 converts the power-supply power supplied from the power supply section 18 and supplies AC power to the heater 23. The power feeding section 29 is capable of performing duty control to change a duty ratio of the AC power under the control of the controller 11. FIG. 6 illustrates an example of the AC power in which a horizontal axis represents time and a vertical axis represents voltage. The duty control is power control that changes an ON/OFF ratio over a plurality of cycles of the AC power supplied to the heater 23. When the voltage of power-supply power (power supply voltage) decreases, even if the duty ratio for turning on the heater 23 is set to 100%, the power does not become equal to the power at a reference voltage. Accordingly, in the present embodiment, the power supplied to the heater 23 is limited such that predetermined power is obtained at a value less than 100%.

To obtain a deterioration state of the fixing section 2, the resistance value sensing section 31 detects a resistance value of the reflecting section 24 serving as a measurement target, and outputs the detected resistance value to the controller 11. As the deterioration state of the reflecting section 24 worsens, the resistance value thereof decreases. Accordingly, the resistance value sensing section 31 detects the resistance value of the reflecting section 24. As shown in FIG. 7, the resistance value sensing section 31 includes a measurement section 310 to calculate the resistance value of the reflecting section 24. The measurement section 310 measures a current value and a voltage value of the reflecting section 24. The measurement section 310 is electrically connected to the reflecting section 24 and includes a power supply 311, an ammeter 312, and a voltmeter 313. The power supply 311 is a regulated power supply capable of outputting a minute constant current. The power supply 311 can output, for example, 0.01 mA. The ammeter 312 is connected in series with the reflecting section 24 and measures the current value of the reflecting section 24. The voltmeter 313 is connected in parallel with the reflecting section 24 and measures the voltage of the reflecting section 24.

Here, in order to detect an extremely low resistance value, the harness connected to the ammeter 312 and the harness connected to the voltmeter 313 are connected to a contact at the same position on the reflecting section 24. Alternatively, the measurement section 310 of a four-wire test probe system, to which lead wires shown by dotted lines in FIG. 7 have been added, is used. The four-wire test probe system can measure the voltage of the measurement target using four lead wires while eliminating an influence of lead wire resistance. The resistance value sensing section 31 calculates the resistance value of the reflecting section 24 according to Equation (1), based on the current value and the voltage of the reflecting section 24 measured by the measurement section 310.

Resistance value [Ω]=voltage [V]/current value [A] (1)

Here, with reference to FIG. 5, a connection pattern of the contacts to be connected in measuring the current value and the voltage of the reflecting section 24 of the measurement target by the measurement section 310 will be described. In a first connection pattern, the lead wires of the measurement section 310 are electrically connected to the contact C1 and the contact C2. In the first connection pattern, the current value and the voltage in a longitudinal direction (x-axis direction) of the reflecting layer 243 between the contact C1 and the contact C2 are measured. As shown in FIG. 3, the fixing section 2 includes a connection terminal 240. The connection terminal 240 is a schematic illustration collectively showing terminals related to the connection between the measurement section 310 and the reflecting section 24. In a second connection pattern, the lead wires of the measurement section 310 are electrically connected to the contact C3 and the contact C4. In the second connection pattern, the current value and the voltage in the longitudinal direction of the base layer 241 between the contact C3 and the contact C4 are measured.

In the third connection pattern, the lead wires of the measurement section 310 are electrically connected to the contact C5 and the contact C6. In the third connection pattern, the current value and the voltage in the thickness direction of the reflecting layer 243 between the contact C5 and the contact C6 are measured. The portion shown in the dotted lines in FIG. 7 indicates each of the layers drawn out for the measurement. In the fourth connection pattern, the lead wires of the measurement section 310 are electrically connected to the contact C7 and the contact C8. In the fourth connection pattern, the current value and the voltage in the thickness direction of the base layer 241 are measured between the contact C7 and the contact C8.

In the fifth connection pattern, the lead wires of the measurement section 310 are electrically connected to a first contact at which the contacts C1 and C3 are joined, and a second contact at which the contacts C2 and C4 are joined. In the fifth connection pattern, a combined current value and a combined voltage of the base layer 241 and the reflecting layer 243 between the first contact and the second contact are measured. In the sixth connection pattern, the lead wires of the measurement section 310 are electrically connected to a third contact at which the contacts C5 and C9 are joined, and to a fourth contact at which the contacts C4 and C6 are joined. In the sixth connection pattern, the combined current value and the combined voltage in a thickness direction of the base layer 241 and the reflecting layer 243 between the third contact and the fourth contact are measured.

In the seventh connection pattern, the lead wires of the measurement section 310 are electrically connected to the contact C1 and the contact C2. Further, in the seventh connection pattern, the lead wires of the measurement section 310 are electrically connected to the contact C3 and the contact C4. In the seventh connection pattern, the current value and the voltage in the longitudinal direction of the reflecting layer 243 between the contact C1 and the contact C2 are measured. Further, the current value and the voltage in the longitudinal direction of the base layer 241 between the contact C3 and the contact C4 are measured.

In the eighth connection pattern, the lead wires of the measurement section 310 are electrically connected to the contact C5 and the contact C6. Further, in the eighth connection pattern, the lead wires of the measurement section 310 are electrically connected to the contact C7 and the contact C8. In the eighth connection pattern, the current value and the voltage in the thickness direction of the reflecting layer 243 between the contact C5 and the contact C6 are measured. Further, the current value and the voltage in the thickness direction of the base layer 241 between the contact C7 and the contact C8 are measured.

The power supply voltage measurement section 32 measures the power supply voltage supplied to the power supply section 18, and outputs the measured power supply voltage to the controller 11. Note that the power supply voltage measurement section 32 may be disposed at a position which is in the image forming apparatus 1 but not in the fixing section 2.

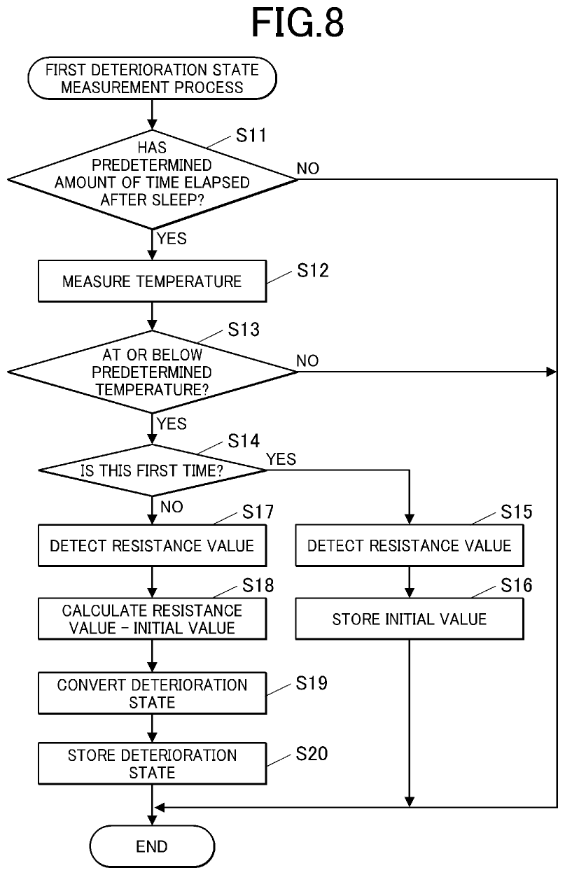

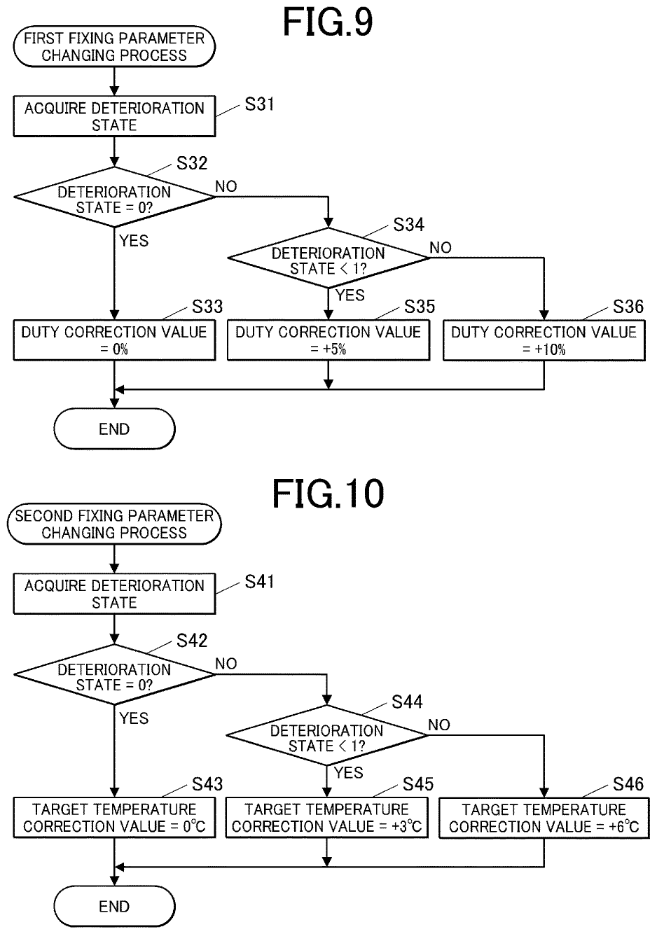

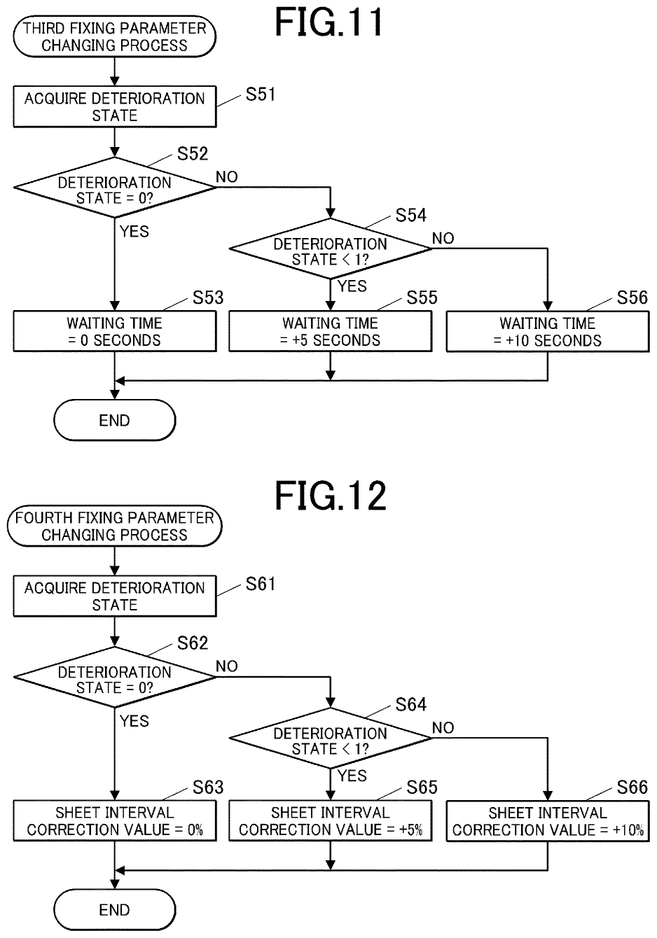

Next, the operation of the image forming apparatus 1 will be described with reference to FIGS. 8 to 14. FIG. 8 is a flowchart showing the first deterioration state measurement process. FIG. 9 is a flowchart showing a first fixing parameter changing process. FIG. 10 is a flowchart showing a second fixing parameter changing process. FIG. 11 is a flowchart showing a third fixing parameter changing process. FIG. 12 is a flowchart showing a fourth fixing parameter changing process.

The first deterioration state measurement process executed by the image forming apparatus 1 will be described with reference to FIG. 8. The first deterioration state measurement process measures the deterioration state of the reflecting section 24 by detecting a resistance value of the reflecting section 24, and reduces variations in the power supply voltage by using the regulated power supply. The first deterioration state measurement process is repeatedly executed at a predetermined cycle. For example, in the image forming apparatus 1, it is time to execute the first deterioration state measurement process. In response to the arrival of the execution timing, the controller 11 executes the first deterioration state measurement process in accordance with a first deterioration state measurement program stored in the storage section 17.

As shown in FIG. 8, the controller 11 determines whether the image forming apparatus 1 is in a sleep state and whether a predetermined time set in advance has elapsed since the start of the sleep state (step S11). If the predetermined time has not elapsed (step S11; NO), the first deterioration state measurement process is terminated. When the predetermined time has elapsed (step S11; YES), the controller 11 measures the temperature of the measurement target using the temperature sensor 28 or 28a (step S12). The measurement target in step S12 is the fixing belt 27 or the reflecting section 24.

The controller 11 determines whether the temperature measured in step S12 is at or below a predetermined temperature set in advance (step S13). If the temperature is higher than the predetermined temperature (step S13; NO), the first deterioration state measurement process ends. When the temperature is equal to or lower than the predetermined temperature (step S13; YES), the controller 11 determines whether execution of step S14 and subsequent steps is being performed for the first time after shipment and installation of the image forming apparatus 1 (step S14). If this is the first time (step S14; YES), the controller 11 measures the current value and the voltage of the reflecting section 24 using the resistance value sensing section 31 (step S15). In step S15, the controller 11 causes the resistance value sensing section 31 to calculate and detect the resistance value of the reflecting section 24 in accordance with Equation (1), using the measured current value and voltage. In step S15, one or two resistance values are detected. The controller 11 stores, as an initial value, the resistance value detected in step S15 in the storage section 17 (step S16). The first deterioration state measurement process ends.

If this is not the first time (step S14; NO), the controller 11 executes step S17. Step S17 is the same as step S15. The controller 11 reads an initial resistance value from the storage section 17, and calculates a difference value by subtracting the initial resistance value from the resistance value measured in step S17 (step S18). In step S18, one or two difference values are calculated. The controller 11 converts the difference value calculated in step S18 into a deterioration state indicating a degree of deterioration of the reflecting section 24 (step S19). The deterioration state of the reflecting section 24 is, for example, a numerical value defined as 0: no deterioration, <1: slight deterioration, and ≥1: severe deterioration.

The controller 11 stores, in the storage section 17, the deterioration state converted in step S19, for example, by overwriting previously stored data (step S20). The first deterioration state measurement process ends.

Next, a first fixing parameter changing process performed by the image forming apparatus 1 will be described with reference to FIG. 9. The first fixing parameter changing process is a process of correcting, as a fixing parameter, the duty ratio of AC power supplied to the heater 23 in accordance with the deterioration state of the reflecting section 24. In the image forming apparatus 1, for example, the image forming apparatus 1 is powered on at the beginning of the day. Upon power-on, the controller 11 executes the first fixing parameter changing process in accordance with a first fixing parameter changing program stored in the storage section 17.

First, the controller 11 reads and acquires the deterioration state of the reflecting section 24 from the storage section 17 (step S31). The controller 11 determines whether or not the deterioration state acquired in step S31 is 0 (step S32). When the deterioration state is 0 (step S32; YES), the controller 11 sets a DUTY correction value of the heater 23 to 0 (step S33). That is, when the reflecting section 24 is not deteriorated, the duty ratio of the heater 23 is not corrected. The first fixing parameter changing process ends.

When the deterioration state is not 0 (step S32: NO), the controller 11 determines whether the deterioration state acquired in step S31 is less than 1 (step S34). If the deterioration state is less than 1 (step S34: YES), the controller 11 sets a DUTY correction value of the heater 23 to +5% (step S35). The first fixing parameter changing process ends. If the deterioration state is greater than or equal to 1 (step S34: NO), the controller 11 sets the DUTY correction value of the heater 23 to +10% (step S36). The first fixing parameter changing process ends. In this manner, the DUTY correction amount is varied in accordance with the degree of deterioration of the reflecting section 24.

Next, with reference to FIG. 10, a second fixing parameter changing process, which is a modification example of the first fixing parameter changing process, will be described. The second fixing parameter changing process corrects, as the fixing parameter, a target temperature for the fixing belt 27 in accordance with the deterioration state of the reflecting section 24. In the second fixing parameter changing process, a description of portions that are the same as those in the first fixing parameter changing process will be omitted.

Steps S41 and S42 are the same as steps S31 and S32 in FIG. 9, respectively. When the deterioration state is 0 (step S42; YES), the controller 11 sets the target temperature correction value of the heater 23 to 0 (step S43). The second fixing parameter changing process ends. Step S44 is the same as step S34 in FIG. 9.

When the deterioration state is <1 (step S44; YES), the controller 11 sets the target temperature correction value of the heater 23 to +3 [°C] (step S45). The second fixing parameter changing process ends. When the deterioration state is ≥1 (step S44; NO), the controller 11 sets the target temperature correction value of the heater 23 to +6 [°C] (step S46). The second fixing parameter changing process ends.

Next, with reference to FIG. 11, a third fixing parameter changing process, which is a modification example of the first fixing parameter changing process, will be described. The third fixing parameter changing process corrects, as the fixing parameter, a waiting time before the sheet enters the fixing section 2, in accordance with the deterioration state of the reflecting section 24. In the third fixing parameter changing process, the description of portions that are the same as those in the first fixing parameter changing process is omitted.

Steps S51 and S52 are the same as steps S31 and S32 of FIG. 9, respectively. When the deterioration state=0 (step S52: YES), the controller 11 sets the waiting time before the sheet enters the heater 23 to 0 [s] (step S53). The third fixing parameter changing process is terminated. Step S54 is the same as step S34 in FIG. 9.

When the deterioration state<1 (step S54: YES), the controller 11 sets the waiting time before the sheet enters the heater 23 to +5 [s] (step S55). The third fixing parameter changing process is terminated. When the deterioration state ≥1 (step S54; NO), the controller 11 sets the waiting time before the sheet enters the heater 23 to +10 [s] (step S56). The third fixing parameter changing process is terminated.

Next, with reference to FIG. 12, a fourth fixing parameter changing process, which is a modification example of the first fixing parameter changing process, will be described. The fourth fixing parameter changing process corrects, as the fixing parameter, a sheet-to-sheet interval for conveyance to the fixing section 2 in accordance with the deterioration state of the reflecting section 24. In the fourth fixing parameter changing process, the description of parts that are the same as those in the first fixing parameter changing process is omitted.

Steps S61 and S62 are the same as steps S31 and S32 of FIG. 9, respectively. When the deterioration state=0 (step S62; YES), the controller 11 sets, to 0 [%], the sheet-to-sheet interval correction value for conveyance to the heater 23 (step S63). The fourth fixing parameter changing process ends. Step S64 is the same as step S34 in FIG. 9.

When the deterioration state is less than 1 (step S64; YES), the controller 11 sets the sheet-to-sheet interval correction value for conveyance to the heater 23 to +5[%] (step S65). The fourth fixing parameter changing process ends. When the deterioration state is ≥1 (step S64: NO), the controller 11 sets the sheet-to-sheet interval correction value for conveying the sheets to the heater 23 to +10[%] (step S66). The fourth fixing parameter changing process ends.

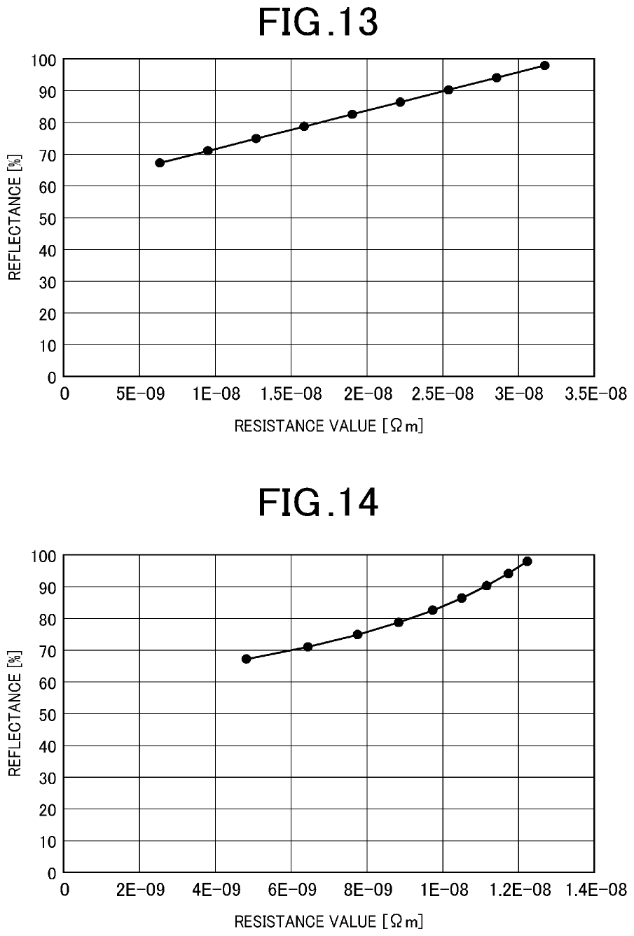

Next, the relationship between the resistance value and the reflectance of the reflecting section 24 will be described with reference to FIGS. 13 and 14. FIG. 13 is a diagram showing the reflectance of the reflecting section 24 with respect to the resistance value in the thickness direction of the reflecting layer 243. FIG. 14 is a graph showing the reflectance of the reflecting section 24 with respect to the resistance value of the combined resistance in the longitudinal direction of the base layer 241 and the reflecting layer 243.

FIG. 13 shows the reflectance [%] of the reflecting section 24 with respect to the resistance value [Ω·m] of the resistance (between the contacts C5 and C6) in the thickness direction of the reflecting layer 243. The reflectance [%] is defined as the reflectance of a light amount with respect to the reflecting section 24. Silver, which is a material of the reflecting layer 243, has a resistance value of 1.59×10⁻⁸ [Ω·m] and a reflectance of 98 [%]. As the amount of silver decreases due to deterioration of the reflecting section 24 and the resistance value [Ω·m] decreases, the reflectance [%] of the reflecting section 24 also decreases.

FIG. 14 illustrates the reflectance [%] of the reflecting section 24 with respect to the resistance value [Ω·m] of the combined resistance (between contacts C1 and C2 and between contacts C3 and C4) in the longitudinal direction of the base layer 241 and the reflecting layer 243. The resistance value of aluminum, which is the material of the base layer 241, is 2.65×10⁻⁸ [Ω m], and the reflectance is 85 [%]. As the amount of silver decreases due to the deterioration of the reflecting section 24 and the resistance value [Ω·m] of the base layer 241 and the reflecting layer 243 decreases, the reflectance [%] of the reflecting section 24 also decreases.

As described above, the image forming apparatus 1 according to the present embodiment includes a fixing device 3. The fixing device 3 is provided in the image forming apparatus 1 and includes the fixing belt 27 and the heater 23. The fixing device 3 includes the reflecting section 24, a deterioration sensing section, a changing section, and a correction section (corrector). The reflecting section 24 reflects heat from the heater 23 toward an inner surface of the fixing belt 27. The controller 11, as a deterioration sensing section, detects the deterioration state of the reflecting section 24. The controller 11, as the changing section, changes the fixing parameter based on the detected deterioration state. The correction section corrects variations in the power supply voltage supplied to the image forming apparatus 1. Accordingly, even in a region with poor power supply conditions, the deterioration state of the reflecting section 24 can be accurately detected, and the fixing parameter can be changed.

The controller 11 detects the resistance value of the reflecting section 24 using the resistance value sensing section 31, and converts to the deterioration state from the detected resistance value. Accordingly, the deterioration state of the reflecting section 24 can be appropriately detected.

The correction section is the power supply 311 of the regulated power supply used to detect the resistance value. Accordingly, even in the region with the poor power supply conditions, the resistance value of the reflecting section 24 can be detected stably, and the deterioration state of the reflecting section 24 can be detected accurately.

The reflecting section 24 is plate-shaped and includes the base layer 241 and the reflecting layer 243 provided on the base layer 241. The controller 11 detects, using the resistance value sensing section 31, a first resistance value (between the contacts C1 and C2) in an in-plane tangential direction (longitudinal direction) of the reflecting layer 243. Alternatively, the controller 11 detects, using the resistance value sensing section 31, a second resistance value (between the contacts C3 and C4) in the thickness direction of the base layer 241. Alternatively, the controller 11 detects, via the resistance value sensing section 31, a third resistance value (between the contacts C5 and C6) in the in-plane tangential direction (longitudinal direction) of the reflecting layer 243. Alternatively, the controller 11 detects, using the resistance value sensing section 31, a fourth resistance value (between the contacts C7 and C8) in the thickness direction of the base layer 241. Alternatively, the controller 11 detects, by the resistance value sensing section 31, the combined resistance value of the first resistance value and the third resistance value. Alternatively, the controller 11 detects, by the resistance value sensing section 31, the combined resistance of the second resistance value and the fourth resistance value.

Alternatively, the controller 11 detects, by the resistance value sensing section 31, the first resistance value and the third resistance value, respectively. Alternatively, the controller 11 detects, by the resistance value sensing section 31, the second resistance value and the fourth resistance value, respectively. Thus, the resistance value of the reflecting section 24 can be appropriately detected, and the deterioration state of the reflecting section 24 can be detected with high accuracy.

When the fixing belt 27 is at or below the predetermined temperature, the controller 11 detects, using the resistance value sensing section 31, the deterioration state based on the resistance value. Thus, since the resistance value is affected by temperature, the resistance value of the reflecting section 24 can be appropriately detected while the temperature remains unchanged.

After a predetermined time elapses from a start of a sleep state of the image forming apparatus 1, the controller 11 detects, by the resistance value sensing section 31, the deterioration state based on the resistance value. Thus, since the resistance value is affected by temperature, the resistance value of the reflecting section 24 can be appropriately detected while the temperature remains unchanged.

The controller 11, as the changing section, increases the electric power supplied to the heater 23 as the deterioration state increases. Alternatively, the controller 11 increases the target temperature for control of the heater 23 as the deterioration state increases. Alternatively, the controller 11 increases the waiting time before conveying the sheet to the fixing device 3 (fixing section 2) as the deterioration state increases. Alternatively, the controller 11 increases the sheet-to-sheet interval for sheet conveyance to the fixing device 3 (fixing section 2) as the deterioration state increases. Thus, the fixing parameter can be appropriately changed.

### Second Embodiment

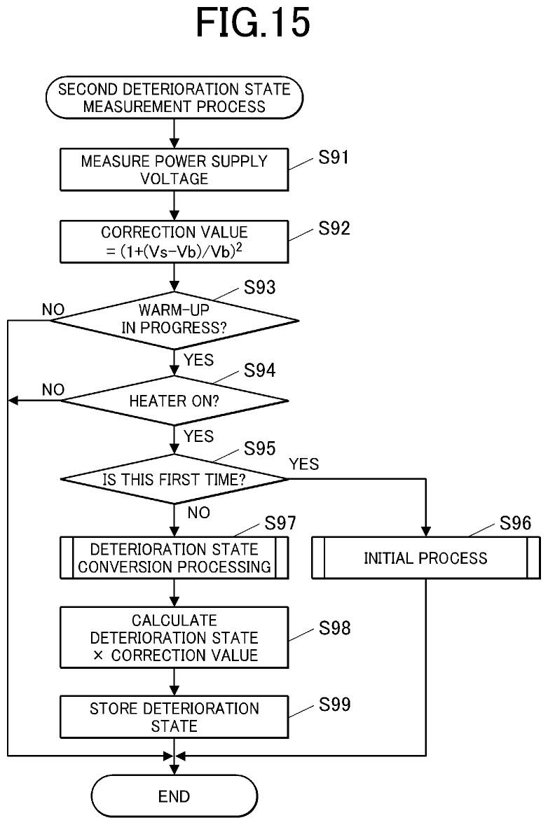

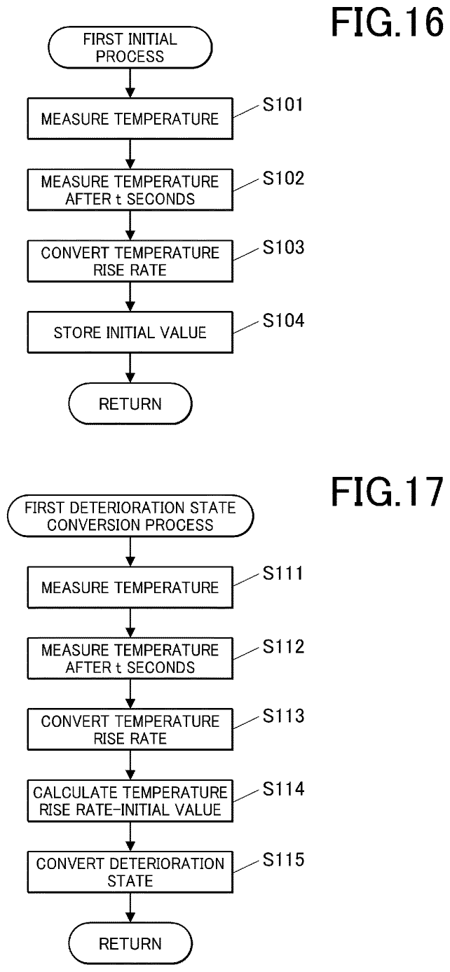

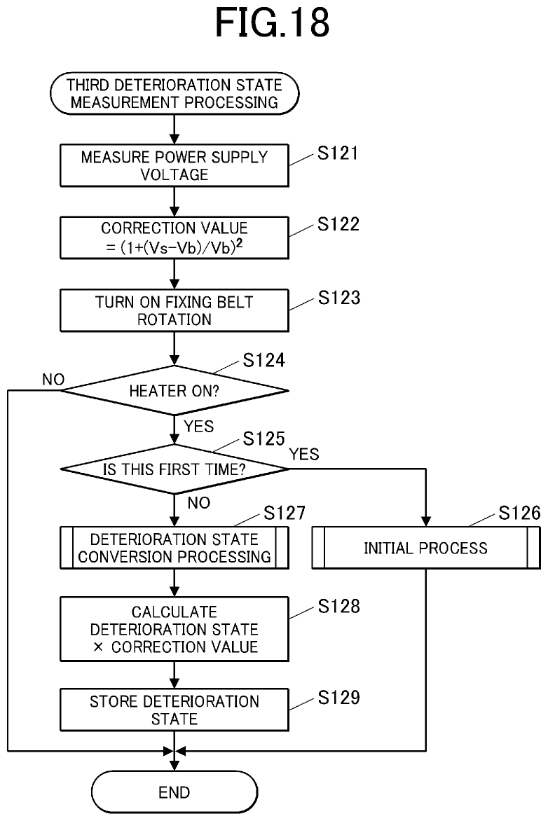

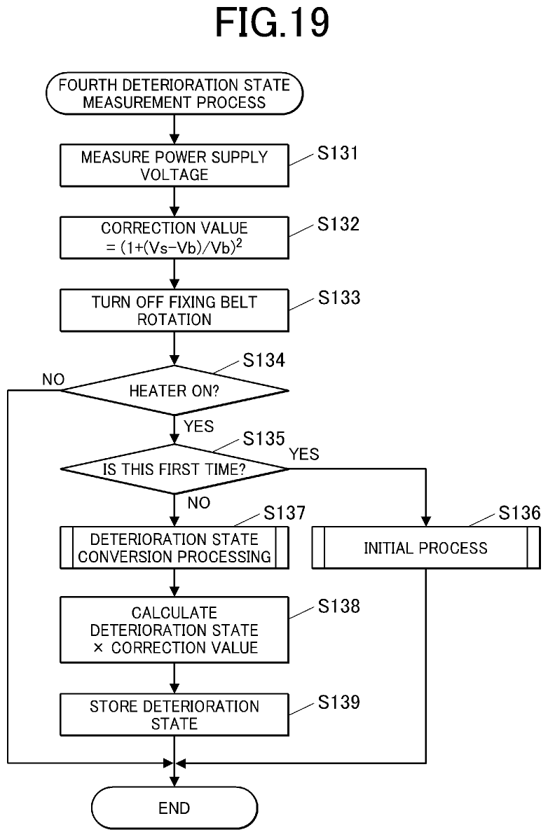

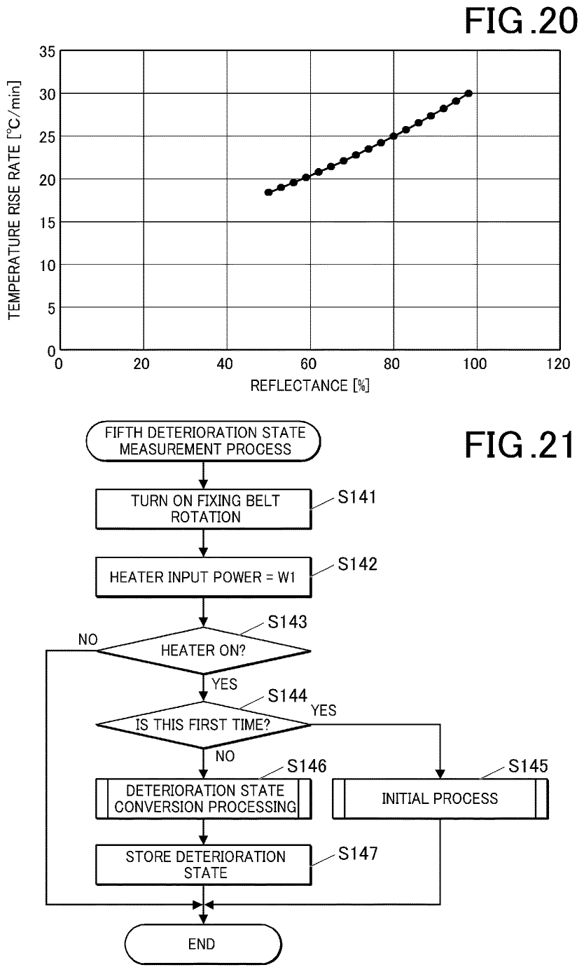

A second embodiment of the present disclosure will be described with reference to FIGS. 15-20. FIG. 15 is a flowchart illustrating a second deterioration state measurement process. FIG. 16 is a flowchart illustrating a first initial process. FIG. 17 is a flowchart illustrating first deterioration state conversion processing. FIG. 18 is a flowchart illustrating a third deterioration state measurement process. FIG. 19 is a flowchart illustrating a fourth deterioration state measurement process. FIG. 20 is a diagram showing a temperature rise rate of the reflecting section 24 with respect to the reflectance of the reflecting section 24.

In the first embodiment, the deterioration state of the reflecting section 24 is measured by detecting the resistance value of the reflecting section 24. According to the present embodiment, the deterioration state of the reflecting section 24 is measured based on the temperature rise rate of the reflecting section 24.

The apparatus configuration of the present embodiment employs the image forming apparatus 1 of the first embodiment. However, in the storage section 17, a second deterioration state measurement program for executing a second deterioration state measurement process described later is stored instead of the first deterioration state measurement program. According to the present embodiment, the controller 11 and the temperature sensor 28 or 28a described later function as the deterioration sensing section. The controller 11 and the power supply voltage measurement section 32 function as the correction section.

Next, the operation of the image forming apparatus 1 will be described with reference to FIG. 15. The second deterioration state measurement process executed by the image forming apparatus 1 will be described. The second deterioration state measurement process measures the deterioration state of the reflecting section 24 based on the temperature rise rate of the reflecting section 24 during normal warm-up, and corrects variations in the power supply voltage. The second deterioration state measurement process is repeatedly executed at a predetermined cycle. For example, in the image forming apparatus 1, it is an execution timing of the second deterioration state measurement process. In response to the execution timing, the controller 11 executes the second deterioration state measurement process in accordance with the second deterioration state measurement program stored in the storage section 17.

First, the controller 11 measures, using the power supply voltage measurement section 32, a power supply voltage Vs of the power supply section 18 (step S91). Using the power supply voltage Vs acquired in step S91 and a reference voltage Vb, the controller 11 calculates, in accordance with Equation (2), a correction value (correction coefficient) for a deterioration state (step S92).

Correction value=(1+(Vs⁻Vb)/Vb)² (2)

This is because the power is W=V²/R (R: resistance value) and is proportional to the square of the voltage. This is because the amount of heat generation and the light amount of the heater 23 are also proportional to the square of the power supply voltage.

The controller 11 determines whether a normal warm-up operation is currently being performed (step S93). When the warm-up operation is not in progress (step S93; NO), the second deterioration state measurement process ends. When the warm-up operation is being performed (step S93; YES), the controller 11 determines whether the heater 23 is ON (fully ON) during the warm-up operation (step S94).

When the heater 23 is not ON (step S94; NO), the second deterioration state measurement process ends. When the heater 23 is ON (step S94; YES), the controller 11 executes step S95. Step S95 is the same as step S14 in FIG. 8. If this is the first time (step S95; YES), the controller 11 executes initial processing (step S96). Here, with reference to FIG. 16, a first initial process as initial processing of step S96 will be described.

The controller 11 measures the temperature of the fixing belt 27 or the reflecting section 24 using the temperature sensor 28 or 28a (step S101). The controller 11 measures the temperature of the fixing belt 27 or the reflecting section 24 using the temperature sensor 28 or 28a after a preset time t seconds has elapsed from step S101 (step S102).

The controller 11 converts to the temperature rise rate based on the temperature measured in step S101 and the temperature measured in step S102 after t seconds (step S103). For example, the temperature rise rate [°C/min] is calculated from the temperature [°C] and the temperature [°C] after t seconds. The controller 11 stores, as an initial value, the temperature rise rate converted in step S103 in the storage section 17 (step S104). The first initial process ends.

Returning to FIG. 15, after execution of step S96, the second deterioration state measurement process ends. If this is not the first time (step S95; NO), the controller 11 executes a deterioration state conversion process (step S97). With reference to FIG. 17, the first deterioration state conversion process, which is the deterioration state conversion process of step S97, will be described.

First, steps S111 to S113 are the same as steps S101 to S103 of the first initial process, respectively. The controller 11 reads the initial value of the temperature rise rate from the storage section 17, and calculates the difference value by subtracting the initial value from the temperature rise rate converted in step S113 (step S114). The controller 11 converts the difference value calculated in step S114 into the deterioration state indicating a degree of deterioration of the reflecting section 24 (step S115). The first deterioration state conversion process ends.

Referring back to FIG. 15, the controller 11 performs step S98 after performing step S97. In step S98, the controller 11 corrects the deterioration state of the reflecting section 24 by multiplying the deterioration state converted in step S97 by the correction value calculated in step S92. Step S99 is the same as step S20 in FIG. 8.

Next, with reference to FIG. 18, a third deterioration state measurement process, as a modification example of the second deterioration state measurement process, will be described. The third deterioration state measurement process is a process for measuring the deterioration state of the reflecting section 24 based on the temperature rise rate of the reflecting section 24 during a warm-up dedicated to the deterioration state correction, and correcting variations in the power supply voltage. The storage section 17 stores a fourth deterioration state measurement program for executing the third deterioration state measurement process. For example, in the image forming apparatus 1, a trigger to start a warm-up dedicated to deterioration state correction is generated. In response to the trigger, the controller 11 executes a third deterioration state measurement process in accordance with a third deterioration state measurement program stored in the storage section 17.

First, steps S121 and S122 are the same as steps S11 and S12 in FIG. 8, respectively. The controller 11 starts rotation of the fixing belt 27 by driving the motor 210 to rotate the pressure roller 21 (step S123). The controller 11 determines whether the heater 23 is ON (fully energized) or not (step S124). When the heater 23 is not ON (step S124; NO), the third deterioration state measurement process ends.

When the heater 23 is ON (step S124; YES), the controller 11 proceeds to step S125. Steps S125 to S129 are the same as steps S95 to S99 of the second deterioration state measurement process in FIG. 15.

Next, a fourth deterioration state measurement process, as a modification example of the second deterioration state measurement process, will be described with reference to FIG. 19. The fourth deterioration state measurement process is a process of measuring the deterioration state of the reflecting section 24 based on the temperature rise rate of the reflecting section 24 while the fixing belt 27 is stopped, in a warm-up dedicated to deterioration state correction. The fourth deterioration state measurement process corrects for variations in the power supply voltage. The storage section 17 stores a fourth deterioration state measurement program for executing the fourth deterioration state measurement process. For example, in the image forming apparatus 1, the trigger to start the warm-up dedicated to the deterioration state correction is generated. In response to the trigger, the controller 11 executes the fourth deterioration state measurement process in accordance with the fourth deterioration state measurement program stored in the storage section 17.

First, steps S131 and S132 are the same as steps S11 and S12 in FIG. 8, respectively. The controller 11 stops driving the motor 210 to stop rotation of the pressure roller 21, thereby stopping rotation of the fixing belt 27 (step S133). Steps S134 to S139 are the same as steps S124 to S129 of the third deterioration state measurement process in FIG. 18.

Also in the present embodiment, the first, second, third, or fourth fixing parameter changing process is executed in the image forming apparatus 1.

Next, with reference to FIG. 20, the relationship between the reflectance of the reflecting section 24 and the temperature rise rate of the fixing belt 27 will be described. FIG. 20 is a graph showing the temperature rise rate of the fixing belt 27 with respect to the reflectance of the reflecting section 24.

FIG. 20 shows a temperature rise rate [%] of the fixing belt 27 with respect to a reflectance [%] of the reflecting section 24. The reflectance [%] is defined as the reflectance of the light amount with respect to the reflecting section 24. As silver decreases due to the deterioration of the reflecting section 24 and the reflectance [%] of the reflecting section 24 decreases, the temperature rise rate [%] of the fixing belt 27 also decreases.

As described above, according to the present embodiment, the controller 11 serving as the deterioration sensing section detects the temperature rise rate of the fixing belt 27 or the reflecting section 24 using the temperature sensor 28 or 28a. The controller 11 converts to the deterioration state based on the detected temperature rise rate. Accordingly, the temperature rise rate of the fixing belt 27 or the reflecting section 24 can be detected, and the deterioration state of the reflecting section 24 can be detected with high accuracy.

The controller 11 detects the temperature using the temperature sensor 28 that detects the temperature of the fixing belt 27, and calculates the temperature rise rate based on the detected temperature. Accordingly, the temperature sensor 28 can also be used as the temperature sensor for adjusting a fixing temperature, and a manufacturing cost of the fixing device 3 can be reduced. Alternatively, the controller 11 detects the temperature using the temperature sensor 28a that detects the temperature of the reflecting section 24, and calculates the temperature rise rate based on the detected temperature. Detecting the temperature of the fixing belt 27 is affected by, for example, an internal temperature of the image forming apparatus 1. However, since the temperature of the reflecting section 24 is directly proportional to the deterioration of the reflecting section 24, accuracy in determining the deterioration state can be further improved.

The controller 11, as the correction section, corrects the deterioration state based on a ratio of the power supply voltage Vs detected by the power supply voltage measurement section 32 that detects the power supply voltage of the power supply section 18 with respect to a reference voltage Vb. Accordingly, even in the region with poor power supply conditions, the temperature rise rate of the reflecting section 24 can be detected, and the deterioration state of the reflecting section 24 can be corrected with high accuracy.

In the second deterioration state measurement processing, the controller 11 sets the detection timing of the deterioration state to be during warm-up and while the heater 23 is on. Accordingly, since the warm-up operation and the deterioration detection operation can be shared, it is possible to eliminate the need to separately perform the operation for detecting the deterioration state.

### Third Embodiment

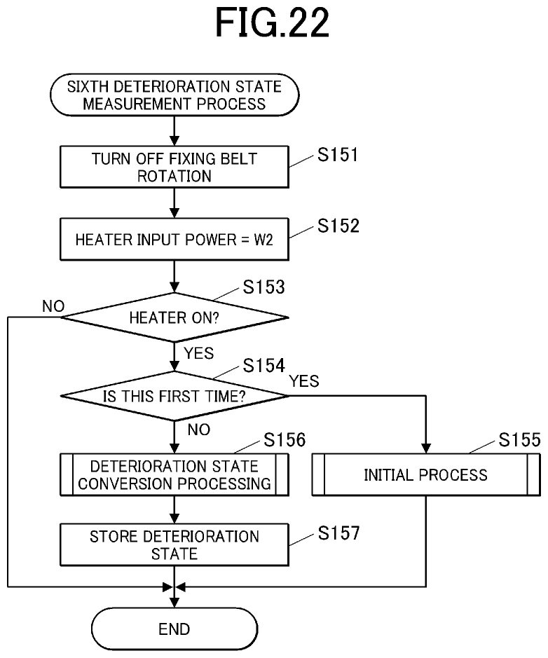

A third embodiment of the present disclosure will be described with reference to FIGS. 21 and 22. FIG. 21 is a flowchart illustrating a fifth deterioration state measurement process. FIG. 22 is a flowchart illustrating a sixth deterioration state measurement process.

In the second embodiment, the deterioration state is measured based on the temperature rise rate of the reflecting section 24, and variation in the power supply voltage is corrected based on the power supply voltage. In the present embodiment, the deterioration state is measured based on the temperature rise rate of the reflecting section 24, and constant power is supplied to the heater 23 to reduce the variation in the power supply voltage.

The apparatus configuration of the present embodiment employs the image forming apparatus 1 of the first embodiment. However, the storage section 17 stores, instead of the first deterioration state measurement program, a fifth deterioration state measurement program for executing the fifth deterioration state measurement process to be described later. The power feeding section 29 supplies the heater 23 with constant AC power limited to a predetermined power level, in accordance with control by the controller 11, regardless of the power supply voltage of the power supply section 18. According to the present embodiment, the controller 11 and the power feeding section 29 function as the correction section.

Next, the operation of the image forming apparatus 1 will be described with reference to FIGS. 21 and 22. Referring to FIG. 21, the fifth deterioration state measurement process executed by the image forming apparatus 1 will be described. The fifth deterioration state measurement process measures the deterioration state of the reflecting section 24 based on the temperature rise rate of the reflecting section 24 during a warm-up dedicated to deterioration state correction. In the fifth deterioration state measurement process, variation in the power supply voltage is reduced by setting heater input power to a constant value. For example, in the image forming apparatus 1, the trigger to start the warm-up dedicated to the deterioration state correction is generated. In response to the trigger, the controller 11 executes the fifth deterioration state measurement process in accordance with the fifth deterioration state measurement program stored in the storage section 17.

First, step S141 is the same as step S123 in the third deterioration state measurement process of FIG. 18. The controller 11 sets AC power of the power feeding section 29 to the predetermined constant heater input power W1 (step S142). In the fifth deterioration state measurement process, the heater 23 is driven at the set constant heater input power W1 during warm-up. Steps S143 to S147 are the same as steps S124 to S127 and S129 of FIG. 18.

Next, referring to FIG. 22, the sixth deterioration state measurement process executed by the image forming apparatus 1 will be described. The sixth deterioration state measurement process is a warm-up operation dedicated to deterioration state correction, and measures the deterioration state of the reflecting section 24 based on the temperature rise rate of the reflecting section 24 while the fixing belt 27 is stopped. In the sixth deterioration state measurement process, variation in the power supply voltage is reduced by setting the heater input power to a constant value. For example, in the image forming apparatus 1, the trigger to start the warm-up dedicated to the deterioration state correction is generated. In response to the trigger, the controller 11 executes the sixth deterioration state measurement process in accordance with a sixth deterioration state measurement program stored in the storage section 17.

First, step S151 is the same as step S133 in the fourth deterioration state measurement process of FIG. 19. The controller 11 sets the AC power supplied by the power feeding section 29 to a predetermined constant heater input power W2 (step S152). Steps S154 to S157 are the same as steps S134 to S137 and step S139 of FIG. 19.

Also in the present embodiment, the first, second, third, or fourth fixing parameter changing process is executed in the image forming apparatus 1.

As described above, according to the present embodiment, the controller 11 serving as the correction section causes the power feeding section 29, which supplies power to the heater 23, to supply constant power limited to a predetermined power level to the heater 23 regardless of the power supply voltage of the power supply section 18. Accordingly, even in the region with poor power supply conditions, the temperature rise rate of the reflecting section 24 can be stably detected, and the deterioration state of the reflecting section 24 can be detected with high accuracy.

The fifth deterioration state measurement process will be considered. The controller 11 sets the detection timing of the deterioration state to the timing that is during warm-up and in which the power supplied to the heater 23 is limited to a predetermined power W1. Accordingly, it is possible to eliminate the influence of variations in the power supply voltage causing the amount of heat generation (light emission amount) of the heater 23 to change, thereby eliminating the influence of variations in the power supply voltage. On the other hand, an operation for detecting the deterioration state other than normal operation is required.

The sixth deterioration state measurement process will be considered. The controller 11 sets the detection timing of the deterioration state to the timing that is during warm-up and when the fixing belt 27 is stopped and the power supplied to the heater 23 is limited to a predetermined power W2. When the fixing belt 27 is being driven, the fixing belt 27 swings, therefore, when the fixing belt 27 is stopped, the temperature can be detected with high accuracy without being affected by heat from components other than the fixing belt 27. Further, when the fixing belt 27 is stopped, the temperature may rise too rapidly and thereby damage the fixing belt 27, therefore, the power supplied to the heater 23 can be set to a lower level.

### Fourth Embodiment

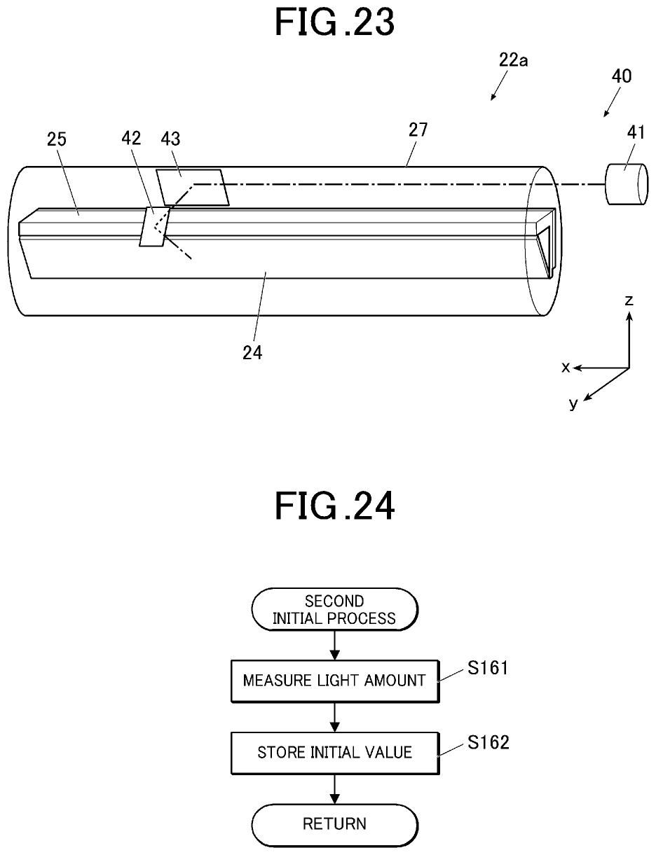

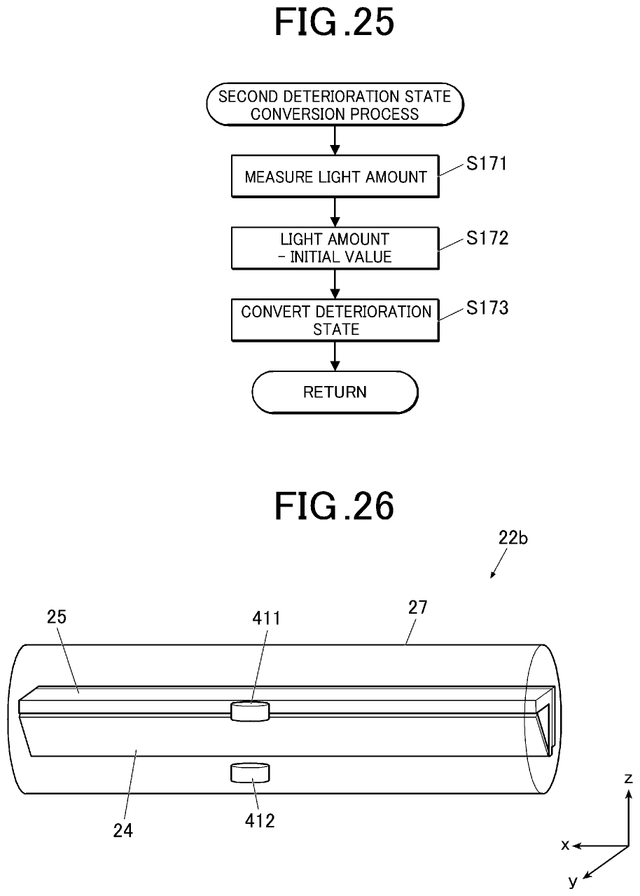

A fourth embodiment of the present disclosure will be described with reference to FIGS. 23 to 26. FIG. 23 is a perspective view of the heating section 22a. FIG. 24 is a flowchart illustrating a second initial process. FIG. 25 is a flowchart illustrating a second deterioration state conversion process. FIG. 26 is a perspective view illustrating the heating section 22b.

In the second and third embodiments, the deterioration state is measured based on the temperature rise rate of the reflecting section 24. In the present embodiment, the deterioration state is measured based on the light amount of the reflected light corresponding to the reflectance of the reflecting section 24.

As illustrated in FIG. 23, the apparatus configuration of the present embodiment is configured such that, in the image forming apparatus 1 of the first embodiment, the heating section 22 is replaced with the heating section 22a. Accordingly, components that are the same as those of the image forming apparatus 1 according to the first embodiment are denoted by the same reference numerals, and a description thereof is omitted. However, in FIG. 23, illustration of the heater 23 and the holding section 270 is omitted. According to the present embodiment, the controller 11 and the temperature sensor 28 or 28a described later function as the deterioration sensing section. The controller 11, the power supply voltage measurement section 32 and the power feeding section 29 function as the correction section.

The heating section 22a includes a light amount measurement section 40 in addition to the components of the heating section 22. The light amount measurement section 40 includes a light amount sensor 41 and reflector plates 42 and 43. The light amount sensor 41 is a sensor that measures the light amount of the reflected light that is emitted from the heater 23, reflected by the reflecting section 24, and then sequentially reflected by the reflector plates 42 and 43. The light amount sensor 41 outputs the measured light amount to the controller 11. The reflector plate 42 is the reflector plate that reflects the light emitted from the heater 23 toward the reflector plate 43. The reflector plate 43 is the reflector plate that reflects the light incident on the reflector plate 43 toward the light amount sensor 41. The reflector plates 42 and 43 and the light amount sensor 41 are arranged, in this order, on the path of the reflected light indicated by a dash-dot line in FIG. 23.

Next, the operation of the image forming apparatus 1 will be described with reference to FIGS. 24 and 25. For example, in the second deterioration state measurement process of FIG. 15, the second initial processing of FIG. 24 will be described as the initial processing in step S96.

As shown in FIG. 24, first, the controller 11 causes the light amount measurement section 40 to measure the light amount of the reflected light emitted from the heater 23 and reflected by the reflecting section 24 (step S161). The controller 11 stores the light amount measured in step S161 in the storage section 17 as the initial value (step S162). The second initial processing ends.

Next, in the second deterioration state measurement process of FIG. 15, the second deterioration state conversion processing of FIG. 25 will be described as the deterioration state conversion processing in step S97. As shown in FIG. 25, step S171 is the same as step S161 of the second initial processing. The controller 11 reads the initial value of the light amount from the storage section 17, and calculates the difference value by subtracting the initial value from the light amount measured in step S171 (step S172). The controller 11 converts the difference value calculated in step S172 into the deterioration state indicating a degree of deterioration of the reflecting section 24 (step S173). The second deterioration state conversion processing ends.

The second initial processing and the second deterioration state conversion processing may be applied to, respectively, the initial processing in step S126 and the deterioration state conversion processing in step S127 of the third deterioration state measurement processing of FIG. 18. The second initial processing and the second deterioration state conversion processing may be applied respectively to the initial processing in step S136 and the deterioration state conversion processing in step S137 of the fourth deterioration state measurement processing of FIG. 19. The second initial processing and the second deterioration state conversion processing may be applied to the initial processing in step S145 and the deterioration state conversion processing in step S146, respectively, of the fifth deterioration state measurement processing of FIG. 21. The second initial processing and the second deterioration state conversion processing can be applied to, respectively, the initial processing in step S155 and the deterioration state conversion processing in step S156 of the sixth deterioration state measurement processing of FIG. 22.

Next, with reference to FIG. 26, the heating section 22b, which is a modification example of the heating section 22a, will be described. The heating section 22b includes a light amount sensor 411 or 412, instead of the light amount measurement section 40. The light amount sensor 411 is disposed at a position at which direct measurement can be performed on an upper side (+z-direction side) of the reflecting section 24. The light amount sensor 411 is a sensor that directly measures the light amount of the reflected light emitted from the heater 23 and reflected by the reflecting section 24. The light amount sensor 411 outputs the measured light amount to the controller 11. The light amount sensor 412 is disposed at a position at which direct measurement can be performed on a lower side (−z-direction side) of the reflecting section 24. The light amount sensor 412 is a sensor that directly measures the light amount of the reflected light emitted from the heater 23 and reflected by the reflecting section 24. The light amount sensor 412 outputs the measured light amount to the controller 11.

As described above, according to the present embodiment, the controller 11, serving as the deterioration sensing section, detects the reflectance of the reflecting section 24, and converts to the deterioration state from the detected reflectance. More specifically, the controller 11 detects the light amount of the reflected light from the reflecting section, and converts the detected light amount into the deterioration state. Accordingly, the light amount of the reflected light from the reflecting section 24 can be detected, and the deterioration state of the reflecting section 24 can be accurately detected.

The heating section 22a is considered. The controller 11 detects the light amount of using reflector plates 42 and 43 that further reflect the reflected light from the reflecting section 24, and the light amount sensor 41 that detects the light amount of the reflected light incident from the reflector plate 43. Also, the heating section 22b is considered. The controller 11 detects the light amount using the light amount sensor 411 or 412, which is disposed at a position at which the light amount of the reflecting section 24 can be directly detected and which directly detects the reflected light. Accordingly, the light amount of the reflected light from the reflecting section 24 can be appropriately detected.

The sixth deterioration state measurement process will be considered. The controller 11 sets the detection timing of the deterioration state to the timing that is during warm-up and when the fixing belt 27 is stopped and the power supplied to the heater 23 is limited to the predetermined power W2. When the fixing belt 27 is being driven, the fixing belt 27 swings, causing the light amount incident on the light amount sensor 41, 411, or 412 to fluctuate. Accordingly, because the fixing belt 27 is stopped, the light amount of the reflected light from the reflecting section 24 can be stably and accurately detected.

The above-described embodiment is merely an example of the fixing device, the image forming apparatus, and the fixing parameter changing method according to the present disclosure, and the present disclosure is not limited thereto. For example, at least two of the first through fourth embodiments may be combined as appropriate.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A fixing device provided in an image forming apparatus and including a fixing belt and a heater, the fixing device comprising:
a reflector configured to reflect heat from the heater toward an inner surface of the fixing belt,
a deterioration sensor configured to detect a deterioration state of the reflector,
a hardware processor configured to change a fixing parameter based on the detected deterioration state; and
a corrector configured to correct a variation in a power supply voltage supplied to the image forming apparatus.

2. The fixing device according to claim 1, wherein the deterioration sensor detects a resistance value of the reflector and converts the detected resistance value into the deterioration state.

3. The fixing device according to claim 2, wherein the corrector is a regulated power supply serving as a power supply used to detect the resistance value.

4. The fixing device according to claim 2, wherein,
the reflector is a plate shape and includes a base layer and a reflecting layer provided on the base layer, and
the deterioration sensor detects a first resistance value in an in-plane tangential direction of the base layer, a second resistance value in a thickness direction of the base layer, a third resistance value in the in-plane tangential direction of the reflecting layer, a fourth resistance value in the thickness direction of the reflecting layer, a combined resistance value of the first resistance value and the third resistance value, or the combined resistance value of the second resistance value and the fourth resistance value.

5. The fixing device according to claim 4, wherein the deterioration sensor detects the first resistance value and the third resistance value, respectively, or detects the second resistance value and the fourth resistance value, respectively.

6. The fixing device according to claim 2, wherein the deterioration sensor detects the deterioration state when the fixing belt is at or below a predetermined temperature.

7. The fixing device according to claim 2, wherein the deterioration sensor detects the deterioration state after a predetermined time has elapsed since the image forming apparatus enters a sleep state.

8. The fixing device according to claim 1, wherein the deterioration sensor detects the reflectance of the reflector and converts the detected reflectance into the deterioration state.

9. The fixing device according to claim 8, wherein the deterioration sensor detects a light amount of reflected light from the reflector and converts the detected light amount into the deterioration state.

10. The fixing device according to claim 9, wherein the deterioration sensor detects the light amount using (i) a reflector plate that further reflects reflected light from the reflector and a first light amount sensor that detects a light amount of the reflected light incident from the reflector plate, or (ii) a second light amount sensor that is disposed at a position where the light amount from the reflector can be directly measured and that directly detects the reflected light.

11. The fixing device according to claim 1, wherein the deterioration sensor detects a temperature rise rate of the reflector, and converts the detected temperature rise rate into the deterioration state.

12. The fixing device according to claim 11, wherein the deterioration sensor detects a temperature using a first temperature sensor configured to detect the temperature of the fixing belt, or a second temperature sensor configured to detect the temperature of the reflector, and calculates a temperature rise rate from the detected temperature.

13. The fixing device according to claim 8, wherein the corrector, by a power feeder configured to supply power to the heater, supplies predetermined power to the heater regardless of the power supply voltage.

14. The fixing device according to claim 8, wherein the corrector corrects the deterioration state based on a ratio between the detected power supply voltage and a reference voltage, the detected power supply voltage being detected by a voltage sensor configured to detect the power supply voltage.

15. The fixing device according to claim 8, wherein the deterioration sensor sets a detection timing of the deterioration state to be during warm-up and while the heater is on.

16. The fixing device according to claim 8, wherein the deterioration sensor sets a detection timing of the deterioration state to be during warm-up and while the power supplied to the heater is limited to a predetermined power.

17. The fixing device according to claim 8, wherein the deterioration sensor sets a detection timing of the deterioration state to be during warm-up, while the fixing belt is stopped, and while the power supplied to the heater is limited to a predetermined power.

18. The fixing device according to claim 8, wherein the hardware processor is configured to, as the deterioration state increases, increase power supplied to the heater, increase a target temperature for control of the heater, increase a waiting time for sheet conveyance to the fixing device, or increase a sheet-to-sheet interval in sheet conveyance to the fixing device.

19. An image forming apparatus comprising the fixing device according to claim 1.

20. A fixing parameter changing method performed in a fixing device that is provided in an image forming apparatus and that includes a fixing belt and a heater, the method comprising:
detecting a deterioration state of a reflector configured to reflect heat from the heater toward an inner surface of the fixing belt;
changing a fixing parameter based on the detected deterioration state; and
correcting a variation in a power supply voltage supplied to the image forming apparatus.
